(19) United States
(12) Patent Application Publication
(10) Pub. No.: US 2022/0347549 A1
(43) Pub. Date: Nov. 3, 2022

(54) Phone Application for creating a Pickleball Tournament Competition

(71) Applicant: Thuy Thi Washburn, Sacramento, CA (US)

(72) Inventor: Thuy Thi Washburn, Sacramento, CA (US)

(21) Appl. No.: 17/244,461

(22) Filed: Apr. 29, 2021

(51) Int. Cl. A63B 71/06

(52) U.S. Cl. CPC A63B 71/0669

(57) ABSTRACT

A method for a Phone Application to create a Pickleball Tournament Competition that will automatically arrange Teams/Players after a unique method of card drawing to scrimmage ever Team/Player once, keep track of each Team/Player ranking, and most importantly, after the bracket scrimmage is completed, the app will automatically produce a playoff schedule for the championship match includes the app to track each Team/Player by their Team Slot assignment, the Standing Tab will update and inform the players with ranking, the Formula Table dictates the sequence of the pairing of Teams/Players to their Bracket Scrimmage, transmit the recorded scores of each game into the “Score” section of the Formula Table, and lastly, the workflow will continue to update Team/Players ranking to code the Playoff Bracket matchups.

### BACKGROUND OF THE INVENTION

### 1. Field of the Invention

The present invention is in the field of Phone Application to create Pickleball Tournament Events with live updates.

### 2. Discussion of the State of the Art

Playing Pickleball in a competitive tournament style is not simple. With matching up teams and figuring team scrimmage can be time consuming. Keeping scores, calculating record of wins, and figuring out top teams can take hours during the event. Errors in calculating wins and points loss can easily be made. Keeping track of a Tournament event can take lots of frustrating time and effort to keep the records correct. Most of all, it takes time away from you to enjoy playing the event yourself.

Another hurdle is sharing the information. There isn't an easy way to share the schedule with players except by updated print outs or verbally announcing the schedule. This is a common problem if the players are not around the area of the announcement or posting. This problem persists throughout the day of the event with event updates, announcing or posting Team/Player ranking, and the Playoff schedule.

Therefore, what is clearly needed is a Phone Application to create Pickleball Tournament Events with live updates shared with players will solve the problems mentioned above.

### SUMMARY OF THE INVENTION

In one embodiment of the invention a method for a Phone Application to create a Pickleball Tournament Competition that will automatically arrange Teams/Players to scrimmage ever Team/Player once, keep track of each Team/Player ranking, and most importantly, after the bracket scrimmage is completed, the app will automatically produce a playoff schedule for the championship match and live updates to the players is provided, comprising the app to track each Team/Player by their Team Slot assignment, the Standing Tab will update and inform the players with ranking, the Formula Table dictates the sequence of the pairing of Teams/Players to their Bracket Scrimmage, transmit the recorded scores of each game into the “Score” section of the Formula Table, and lastly, the workflow will continue to update Team/Players ranking to code the Playoff Bracket matchups.

Also, in one embodiment a method for a Phone Application to Rank Team/Player. The present invention will keep track of wins and points loss once the score of each game is entered. The processor will automatically calculate each team's record of wins and points loss. From these records, the processor will determine every Team/Player's ranking. Next, the present invention app will create a Playoff Bracket schedule for the Championship match. The processor will determine the team's placement in the playoff Bracket schedule based on the processors automatically calculated Teams/Player's ranking. This step is performed automatically by the processor with every bracket scrimmage game score entered.

Also, in one embodiment of the invention, the present invention app offers several Pickleball Event Formats, Teams Event is where a team has already been identified. In a Teams Event, the processor only has to arrange the teams to play with every team once. Also, in one embodiment, Round Robin-Team ups is a system format for Men's or a Women's Event is where each player will play with another player once. Another type of Round Robin Team-ups is a Mix Double format. In this format the processor will team up a male player with a female player once.

Also, in one embodiment of the invention, the present invention app's ability is to share the Tournament Event with players via texting. The Event Creator can text and share the Event with the players. The Event Creator can also text the players with updated event changes or event messages to the players through the app. The players can also send a text message to all the players through the app. All event updates are live and shared to all the players instantly through the present invention app.

In another aspect of the invention, a system where the present invention app uses a novel method for Teams/Players to randomly draw cards to determine their Team/Player slot number. The processor will randomly provide and display cards for the players to select. Once a card is selected, that card number will no longer be available for another team to draw from.

In another aspect of the invention, the present invention app offers a unique type of system for a new Pickleball game format. The present invention format game comprises of 4 men and 4 women players. The men will play Round Robin within the men's group and the women will play a Round Robin within the women's group. Then both groups will combine to play a Round Robin of Mix Double where each man will play with each women player. Each player will play a total of 7 games in this format of Pickleball scrimmage. The Champion will be determined in each group and an overall Champion will also be declared.

### BRIEF DESCRIPTION OF THE DRAWING FIGURES

FIG. 1 is an elevation view of the Home page on the present invention phone app.

FIG. 2 is an elevation view of the Create an Event page on present invention phone app.

FIG. 3 is an elevation view of the Event information page on the present invention phone app.

FIG. 4 is an elevation view of the Playoff selection page on the present invention phone app.

FIG. 5 is an elevation view of the Scrimmage Bracket Schedule page on the present invention phone app.

FIG. 6 is an elevation view of the Event Standing page on the present invention phone app.

FIG. 7 is an elevation view of the Team/Player Summary page on the present invention phone app.

FIG. 8 is an elevation view of the Playoff Bracket View page on the present invention phone app.

FIG. 9 is an elevation view of the Score Board for the Playoff page on the present invention phone app.

FIG. 10 is a process flow chart illustrating the connectivity between the pages according to an embodiment of the present invention phone app.

### DETAILED DESCRIPTION

The present invention provides a unique tool to quickly create a Pickleball tournament type of play for a group of players. The Novelty of this app is; once you set it, you can forget it! When the Event Creator selects the Play Style desired, and detailing the Event with a name, date, and time, within minutes, the phone app is ready to be used and shared to be viewed by all players. The present invention is described in enabling detail in the following examples, which may represent more than one embodiment of the present invention.

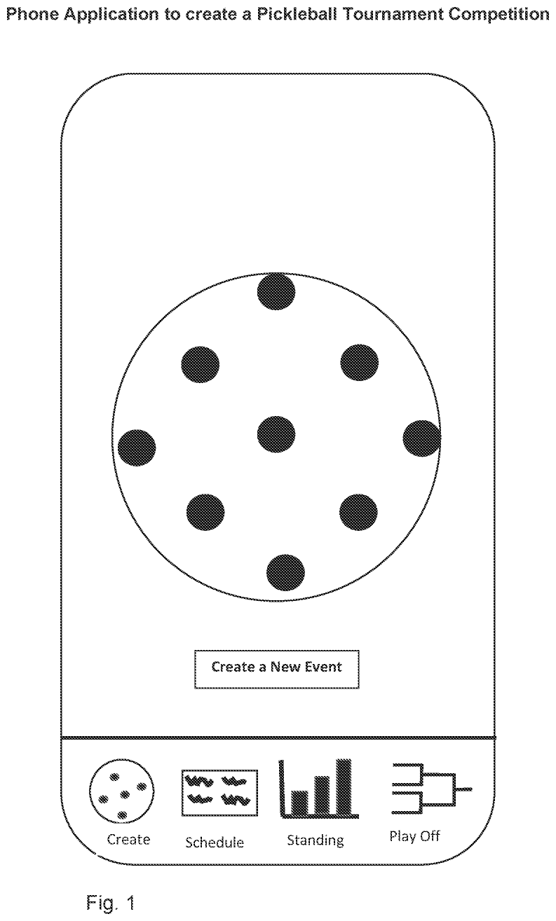

FIG. 1 is an elevation view of the Home page. From the Home page, the user (Event Creator) can select “create an event” or go to the Create tab from the toolbar at the bottom of the Home Page. By selecting “create an event”, the app will lead the user to the Event Format page.

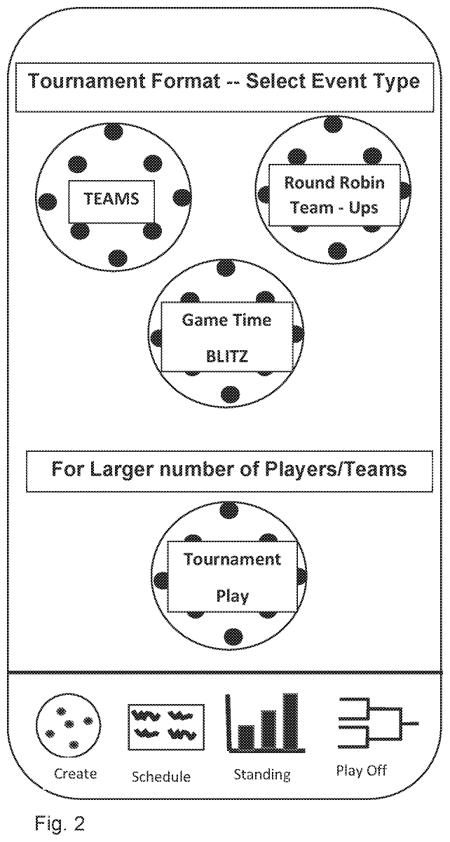

FIG. 2 is an elevation view of the Create an Event page. On this page is step 1, the Event Creator can select the type of event (Teams, Round Robin Team-ups, Game Time Blitz, or larger event option). This app will process accordingly to the user's selection of tournament event type. Teams is where a set team will be playing together. For an event of a Women's or a Men's Team, the app will create a scrimmage schedule to ensure each team will play against every team.

Round Robin Team-ups (Men's or Women's) is where the app processor will pair players together to play with every player once. Another selection is the Mix Double Round Robin Team-ups, the app will create a scrimmage schedule by pairing each male player with every female player once in the bracket scrimmage.

Another novelty Game Time Pickleball app offer is a unique type of Pickleball game format. Game Time Blitz comprise of 4 men and 4 women players. The men will play Round Robin within the men's group and the women will play a Round Robin within the women's group. Then both groups will combine to play a Round Robin of Mix Double where each man will play with each women player. Each player will play a total of 7 games in this format of Pickleball scrimmage. The Champion will be determined in each group and an overall Champion will also be declared.

Lastly, the Event Creator can select the large event option. This option is for multiple brackets or larger number of Teams and Players. This option is ideal for Club Tournaments.

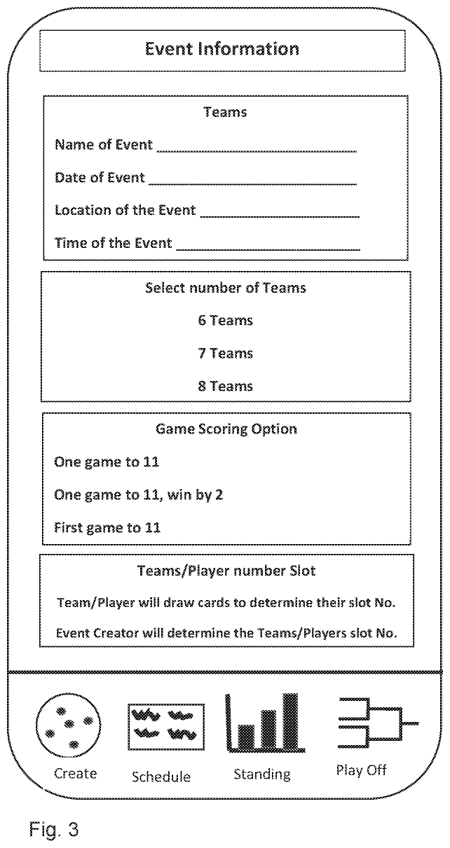

FIG. 3 is an elevation view of the Event information page. This page will depend on what type of event was selected from the event page in FIG. 2. The Event Creator will enter the name of the event, date, time, location of the event, number of teams for “Teams” or number of players for “Round Robin Team-Ups”. The Event Creator will also select the desired game scoring format and has an option to allow players to enter their scores or the Event Creator can select only the Event staffs can enter the scores. And Lastly, the Event Creator will select if the players will draw cards to determine their Team/Player slot number or if the Even Creator will determine each Team/Player slot.

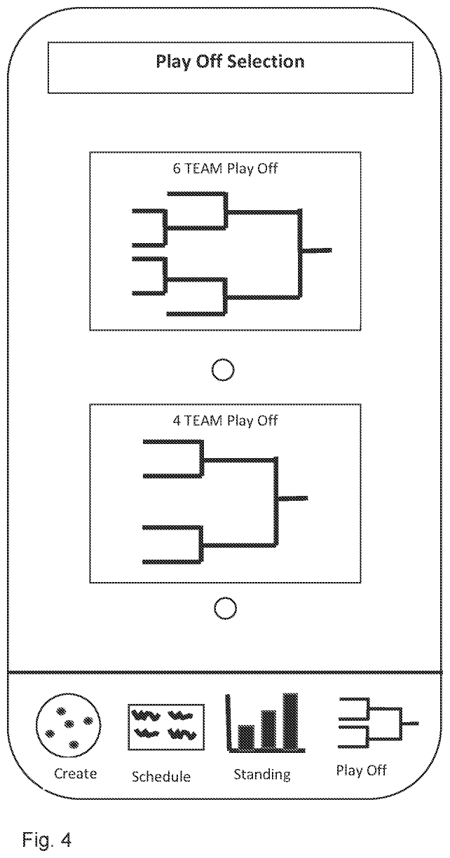

FIG. 4 is an elevation view of the Playoff selection page. On this page, the Event Creator can select different types of playoff. All Teams/Players can go to playoffs or less teams go to playoffs. This will give the Event Creator flexibility depending on amount of court time.

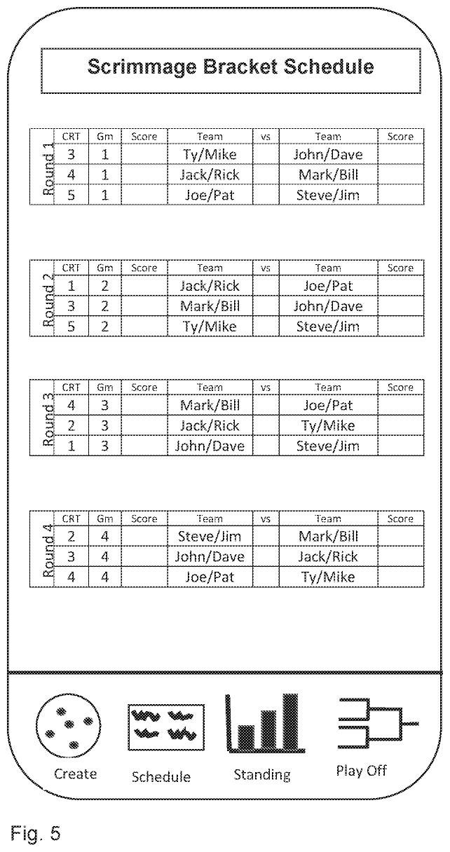

FIG. 5 is an elevation view of the Scrimmage Bracket Schedule. On this page, the Teams/Players can see their upcoming games. This page also allows the players to enter their game score and the page will be updated for all players to view within seconds.

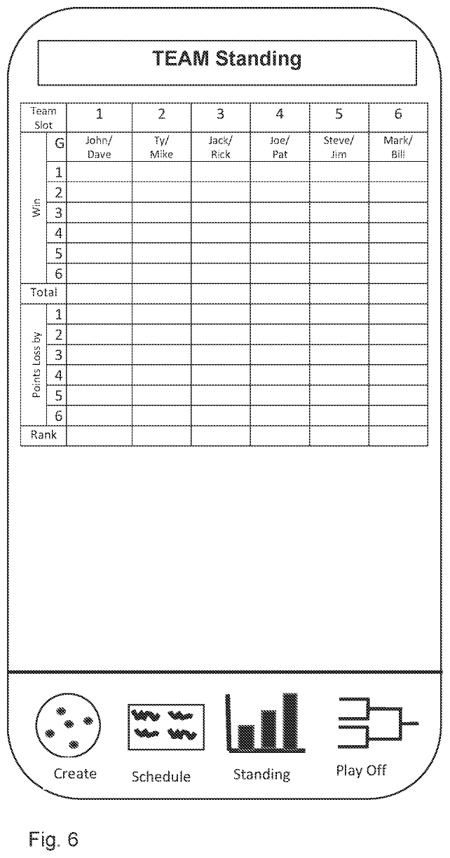

FIG. 6 is an elevation view of the Event Standing page. This page displays all the Team/Player record of wins and record of points loss in each game. This page also displays the Team/Player ranking at real time. The Event Standing page will update within seconds after every new score is recorded from a new game.

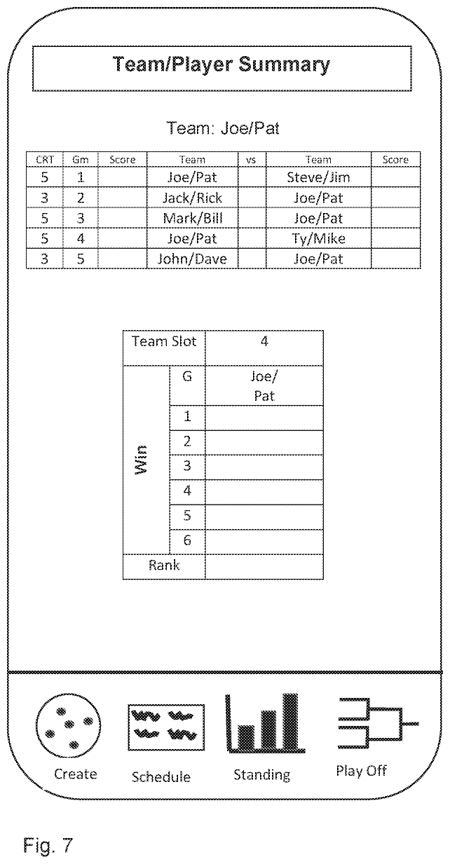

FIG. 7 is an elevation view of the Team/Player Summary page. On this page, the Team/Player can easily view their game schedule and their ranking status. This page is a summary of only the Team/Player selected to view. Players can also select other Teams/Players to view their summary status.

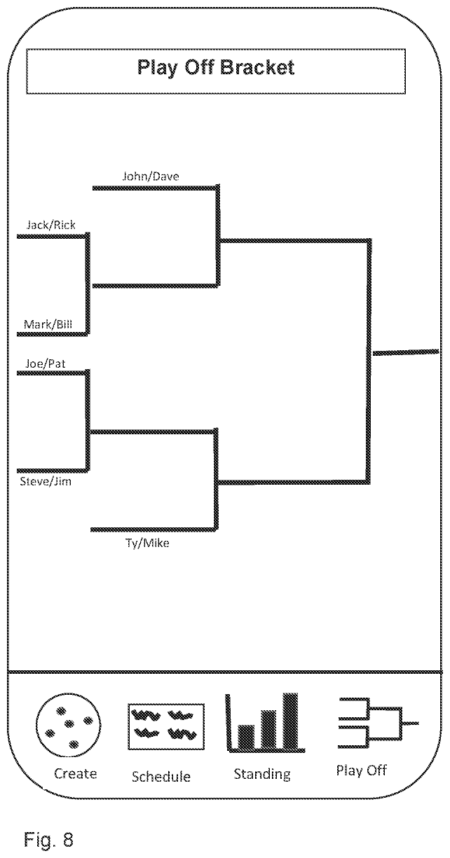

FIG. 8 is an elevation view of the Playoff Bracket View page. After the completion of the scrimmage games, the present invention app will calculate and create a playoff schedule (based on how many teams the Event Creator selected to advance to the Playoff Round).

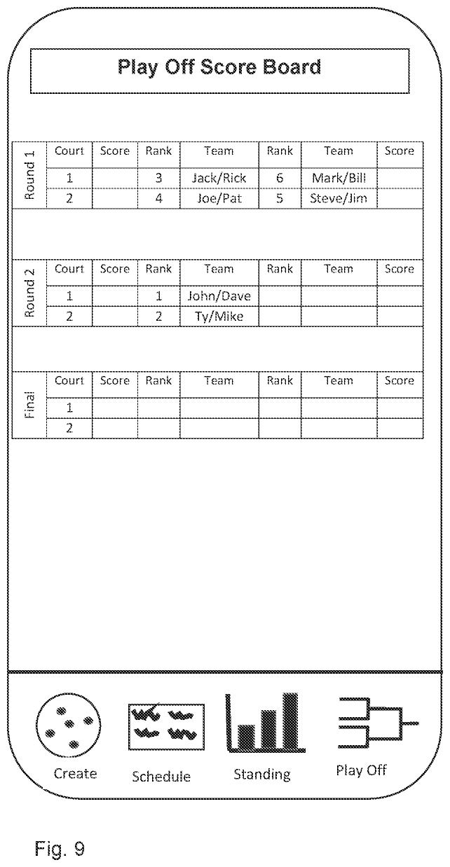

FIG. 9 is an elevation view of the Score Board for the Playoff page. On this page, the players will enter their Playoff game score. The Event Creator has an option to allow players to enter the score or only the Event staffs can.

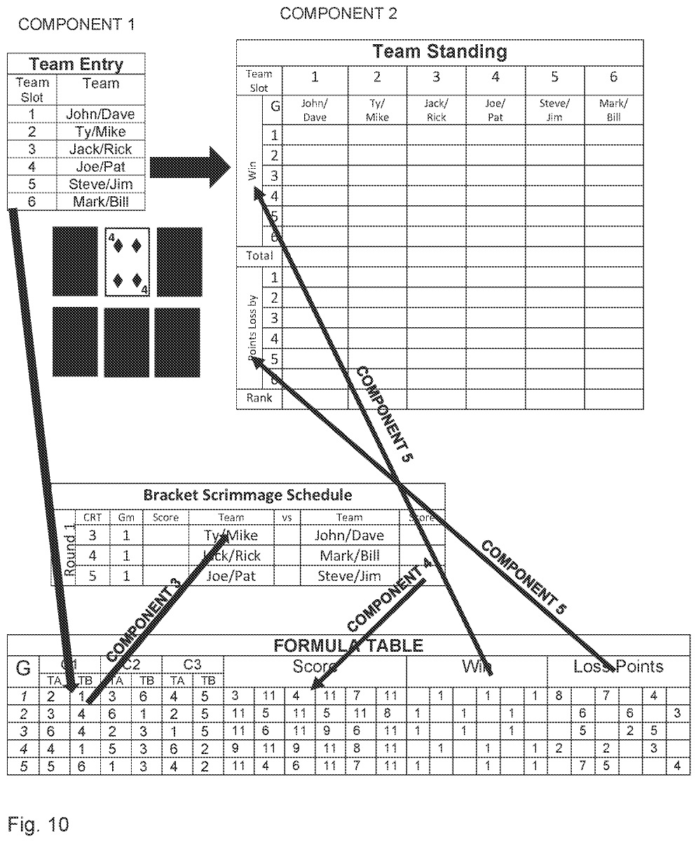

FIG. 10 is the present invention process flow chart illustrating the method connectivity between the pages. The illustration of the process flow chart highlights 5 key method components to connect and link the pages together according to an embodiment of the invention.

Component 1 determines the Team/Player into their “Team Slot”. The Team Slot number is a critical throughout the present invention app. The app has two methods to determine Team/Player slot number. The first method, the Event Creator may select Team/Players draw cards to determine their Team/Player slot number. In this method, the app will provide a set of random cards for the players to draw from to determine their Team/Player slot number. The second method is simple, the Event Creator can enter the Teams/Players into the Team/Slot table himself. The Team Slot number is the key factor to keep track of each Team/Player according to an embodiment of the present invention.

Once the Team Slot is defined for each Team/Player, the Team/Player will be displayed in the Standings Tab. The Component 2 is the Standing Tab where the method of process will update and inform the players with their winning record and points lost. Along with the game stats, Teams and Players can see their current ranking according to an embodiment of the present invention.

The Formula Table is a method of process where the workflow records all the key elements to calculate Team/Player information. In component 3, the Formula Table dictates and process the sequence of the pairing of Teams/Players to their Bracket Scrimmage Schedule according to an embodiment of the invention (example; Team 2 vs. Team 1 or Ty/Mike vs. John/Dave).

Component 4 is a method of process where the processor will transmit the recorded scores from the Bracket Scrimmage Schedule of each game into the “Score” section of the Formula Table. The data is then calculated into Wins or Loss Points according to an embodiment of the invention.

Component 5 is a method of process where the processor will transfer the calculated Wins or Loss Point into the Standing Table for Team/Player Ranking. The workflow will continue to update with every new game played and score entered. When all games are completed, the Standing Table will have rank all the Team/Player to code the Playoff Bracket matchups according to an embodiment of the invention (FIG. 8 and FIG. 9).

It will be apparent to one with skill in the art that the Phone Application for creating a Pickleball Tournament Competition of the invention may be provided using some or all of the mentioned features and components without departing from the sprit and scope of the present invention. It will also be apparent to the skilled artisan that the embodiments described above are specific examples of a single broader invention which may have a greater scope than any of the singular descriptions taught. There may be many alterations made in the descriptions without departing from the spirit and scope of the present invention.

1: A Phone Application to create a Pickleball Tournament Competition comprising a method that will automatically arrange Teams/Players to scrimmage ever Team/Player once, keep track of each Team/Player ranking, and most importantly, after the bracket scrimmage is completed, the app will automatically produce a playoff schedule for the championship match and live updates to the players by comprising these steps:
Step A. Component 1 (FIG. 10), determines the Team/Player into their “Team Slot”. The Team Slot assignment is critical throughout the Game Time Pickleball App. The app has two methods to determine Team/Player slot number. The first method, the Event Creator may select Team/Players draw cards to determine their Team/Player slot number. In this method, the app will provide a set of random cards for the players to draw from to determine their Team/Player slot number. The second method is simple, the Event Creator can enter the Teams/Players into the Team/Slot table himself. The Team Slot number is the key factor to keep track of each Team/Player according to an embodiment of the present invention.
Step B. Component 2 (FIG. 10), is the Standing Tab which will update and inform the players with their winning record and points lost. Along with the game stats, Teams and Players can see their current ranking according to an embodiment of the present invention.
Step C. Component 3 (FIG. 10), is the Formula Table where the workflow records all the key elements to calculate Team/Player information. In component 3, the Formula Table dictates the sequence of the pairing of Teams/Players to their Bracket Scrimmage schedule according to an embodiment of the invention (example; Team 2 vs. Team 1 or Ty/Mike vs. John/Dave).
Step D. Component 4 (FIG. 10), will transmit the recorded scores of each game into the “Score” section of the Formula Table. The data is then calculated into Wins or Loss Points according to an embodiment of the invention.
Step E. Component 5 (FIG. 10), transfer the calculated Wins or Loss Point into the Standing Table for Team/Player Ranking. The workflow will continue to update with every new game played and score entered. When all games are completed, the Standing Table will have ranked all the Team/Player to code the Playoff Bracket matchups according to an embodiment of the invention (FIG. 8 and FIG. 9).

2: A Phone Application of claim 1, further comprising a method to Rank Team/Player. Game Time Pickleball app will keep track of wins and points loss once the score of each game is entered. The processor will automatically calculate each team's record of wins and points loss. From these records, the processor will determine every Team/Player's ranking. Next, the Game Time Pickleball app will create a Playoff Bracket schedule for the Championship match. The processor will determine the team's placement in the playoff Bracket schedule based on the processors automatically calculated Teams/Player's ranking. This step is performed automatically by the processor with every bracket scrimmage game score entered.

3: A Phone Application of claim 1, further comprising a method offering several Pickleball Event Formats, Teams Event is where a team has been identified. In a Teams Event, the processor will arrange the teams to play with every team once.
Round Robin-Team ups is a system format for a Men's or a Women's Event where each player will play with another player once. Another type of Round Robin Team-ups is a Mix Double format. In this format the processor will team up a male player with a female player once.

4: Lastly, a Phone Application of claim 1, further comprising a novelty method of the present invention app's ability to share the Tournament Event with players via texting. The Event Creator can text and share the Event with the players. The Event Creator can also text the players with updated event changes or event messages to the players through the app. The players can also send a text message to all the players through the app. All event updates are live and shared to all the players instantly through the Game Time Pickleball app.

5: A system where the present invention app uses a novel method comprising for Teams/Players to randomly draw cards to determine their Team/Player slot number. The processor will randomly provide and display cards for the players to select. Once a card is selected, that card number will no longer be available for another team to draw from.

6: Another novelty of the present invention app comprising a unique type of system for a new Pickleball game format. The present invention format game comprises of 4 men and 4 women players. The men will play a Round Robin event within the men's group and the women will play a Round Robin event within the women's group. Then both groups will combine to play a Round Robin of Mix Double event where each man will play with each women player. Each player will play a total of 7 games in this format of Pickleball scrimmage event. The Champion will be determined in each group and an overall Champion will also be declared.
